(19) United States
(12) Patent Application Publication
(10) Pub. No.: US 2012/0085217 A1
(43) Pub. Date: Apr. 12, 2012

(54) Violin family musical instrument tone bar

(76) Inventor: Christopher Threlkeld-Wiegand, Iowa City, IA (US)

(21) Appl. No.: 12/924,896

(22) Filed: Oct. 7, 2010

(51) Int. Cl. G10D 1/02

(52) U.S. Cl. 84/276

(57) ABSTRACT

A tone bar may be adapted to mate to the inside surface of a violin family instrument sound board on the treble side of the sound board. The tone bar may comprise natural materials, such as spruce wood or cedar wood, or may comprise synthetic materials, such as carbon fiber material. A tone bar may include areas or materials configured to reduce the mass of the tone bar.

### FIELD

The present invention relates to stringed musical instruments and, in particular, to violin family instruments.

### BACKGROUND

The violin family of musical instruments includes the violin, viola, cello, and bass. Each of these instruments includes a set of strings supported between the instrument's nut and bridge, and a body that amplifies the vibration of the strings. Vibration of the strings is transferred to the body largely through the motion of the bridge. The body includes a top plate, bottom plate, and sides. These are also referred to, respectively, as: sound board, back plate, and ribs. “F” holes in the top plate allow sound, in the form of pressure waves, to propagate outward from the body of the instrument.

Violin family musical instruments also include a bass bar and a sound post. Bass bars appear to have been introduced to violin family instruments by Gassparo da Salo in the sixteenth century. A bass bar, located inside the sound board proximate the bass foot of the bridge and running perpendicular to the bridge, supports an instrument's sound board against downward pressure created by taught strings. A bass bar may also serve to distribute energy from the bass foot of the bridge to a large portion of the sound board. A sound post, typically a wooden dowel, is lodged between the top and back plates of the instrument, in the vicinity of the treble foot of the bridge. Although it is generally believed that the sound post's primary function is to transfer vibrational energy from the top to back plate, there is some evidence to suggest that the sound post creates a node for high-frequency top plate vibrations. That is, when properly positioned, a sound post tunes in high frequency modes in the top plate, forming a small vibration zone with the sound post at a node and the treble foot of the bridge at an anti-node.

Steel strings have long-since replaced the gut strings of Stradivari and da Salo and the increased tension of steel strings results in substantially greater downward pressure on an instrument's top plate. Bass bars have increased in thickness to support the increased pressure, but the increased mass of the bass bar tends to damp an instrument's response, particularly at the low fundamental frequency. This damping of the low fundamental frequency is more pronounced in the larger instruments, with the greatest deficiency evidenced in the bass.

Various methods and apparatuses have been proposed to improve the performance of violin family instruments. Such approaches are described, for example, in U.S. Pat. No. 3,494,239 to Kasha, U.S. Pat. No. 5,381,714 to Kasha, U.S. Pat. No. 5,831,191 to Zaret, U.S. Pat. No. 6,627,802 to Jones, and U.S. Pat. No. 6,284,957 to Leguia. A method and apparatus for improving the performance of violin family stringed instruments would be highly desirable.

### SUMMARY

In an apparatus and method in accordance with the principles of claimed subject matter, a tone bar may be configured as a treble-side tone bar (also referred to herein as a “treble bar”) for a violin-family stringed musical instrument. In another aspect of an apparatus and method in accordance with the principles of claimed subject matter, a violin family stringed musical instrument tone bar may include features or materials that reduce the mass of a tone bar relative to the mass of conventional tone bars, thereby reducing the damping effects of the tone bar while providing substantially the same support for the instrument's top plate as a conventional tone bar. A violin family stringed musical instrument in accordance with the principles of claimed subject matter may include a treble bar, a bass bar, or both, either or both of which may be reduced-mass tone bars in accordance with the principles of claimed subject matter. A tone bar in accordance with the principles of claimed subject matter may, preferably, have a substantially straight-line axis along the longest dimension of the tone bar. When combined with a top plate the long axis extends from the neck-end to the foot-end of the along a line that is within ±50° of the instrument axis.

In an illustrative embodiment, a reduced-mass tone bar includes a first surface adapted for mating with the inside surface of a violin family stringed musical instrument top plate and a body configured to project toward a position that would be occupied by the back plate of an instrument to which a tone bar may be coupled. A violin family stringed musical instrument's top plate may also be referred to as the soundboard. The body of a tone bar may project in a direction that is generally perpendicular to the top plate of the instrument to which it is to be attached. That is, because a violin family musical instrument soundboard is typically arched, the arching may vary from instrument to instrument and the surface may exhibit a varying set of curves, the direction in which the tone bar body may project may be described as generally perpendicular to the plane of the top plate to which it is attached, with the plane of the top plate being defined by the circumferential edge of the top plate.

As is known in the art, the direction of projection needn't be exactly perpendicular to such a plane and, in fact, may vary considerably, as much as ±50°, for example. In an illustrative embodiment a tone bar includes at least one region in which the projecting body is narrower than the first surface that is adapted for mating with the inside surface of the violin family instrument soundboard. Such narrowing of the tone bar may be manifested as a “T-shaped” or “I-shaped” cross section, for example, with the first, or top, surface forming the “cross,” or crossing member, of a T shape or one of the “crosses” of an I shape. Similarly, open regions may be formed in the projecting body. The mass of a tone bar may also be reduced by including narrow regions, such as one or more tapered ends of the bar.

Such narrowings of, or openings within, the projecting body reduce the mass of the tone bar, while, at the same time maintaining the support function of the bar. Such a bar thereby provides the support for an instrument's top plate, while allowing for greater responsiveness to excitation of the instrument's strings. A tone bar in accordance with the principles of claimed subject matter may include natural materials, such as cedar, or spruce, or synthetic materials, such as carbon fiber, meta-aramid (e.g., Nomex®), or para-aramid (e.g., Kevlar®) material, for example. Laminates and combinations of natural and synthetic materials are contemplated within the scope of the invention.

In another illustrative embodiment, a tone bar in accordance with the principles of claimed subject matter includes a first surface adapted for mating with the inside surface of the treble side of a violin family soundboard and a tone bar body that may project generally perpendicular to the plane of the top plate to which it is attached. Such a tone bar may exhibit an otherwise conventional, substantially rectilinear, shape, for example. In other embodiments, such a tone bar, also referred to herein as a “treble bar,” may be formed in a reduced-mass manner, employing, for example, at least one region in which the body is narrower than the first surface that is adapted for mating with the inside treble surface of the violin family instrument soundboard. Again, such narrowing of the tone bar may be manifested as a “T-shaped” or “I-shaped” cross section, for example, with the first surface forming the cross of a T shape or one of the crosses of an I shape. Mass reduction may also be achieved, as previously described, by including openings within the body of the bar, for example. The tone bar may be composed of natural materials, such as cedar, or spruce, or synthetic materials, such as carbon fiber, meta-aramid (e.g., Nomex®), or para-aramid (e.g., Kevlar®) material, for example. Laminates and combinations of natural and synthetic materials are contemplated within the scope of the invention.

In another illustrative embodiment, a violin family instrument includes a tone bar located on the inside treble side of the instrument's soundboard. The tone bar may be integral to the soundboard or may be coupled to the inside of the soundboard using, for example, and adhesive such as an animal hide glue. Such an instrument may also include a tone bar located on the inside bass side of the instrument's soundboard. Either tone bar may exhibit an otherwise conventional, substantially rectilinear, shape, or may include a reduced mass region, with at least one region in which the body is narrower than the first surface that is adapted for mating with the inside treble surface of the violin family instrument soundboard, for example. Such narrowing of the tone bar may be manifested as a “T-shaped” or “I-shaped” cross section, for example, with the first surface forming the cross of a T shape or one of the crosses of an I shape. Openings may be included within the body of either bar to reduce the mass of the respective bar and to thereby reduce damping attributable to the bar.

Either tone bar in such illustrative embodiments may be composed of natural materials, such as cedar, or spruce, or synthetic materials, such as carbon fiber, for example. Laminates and combinations of natural and synthetic materials are contemplated within the scope of the invention. Violin family musical instruments in accordance with the principles of claimed subject matter may include one or more tone bars that are either attached to, or integral with, the instrument. Because a treble bar provides support for an instrument's top plate, instruments that include both a bass bar and a treble bar, may employ a smaller bass bar than would be conventional, thereby further reducing mass and improving responsiveness. Whether used in conjunction with reduced-mass or reduced-dimension tone bars, it is believed that a treble bar in accordance with the principles of claimed subject matter may improve a violin family stringed musical instrument's responsiveness and playability. That is, a violin family stringed musical instrument that includes a treble bar in accordance with the principles of claimed subject matter may allow for less stringent requirements on bow-placement, bow-pressure, and bow speed, for example.

### BRIEF DESCRIPTION OF THE FIGURES

Non-limiting and non-exhaustive embodiments will be described with reference to the following Figures, wherein like reference numerals refer to like parts throughout the various Figures unless otherwise specified.

FIGS. 1A through 1D are elevation views of a tone bar in accordance with the principles of claimed subject matter;

FIGS. 2A through 2H are sectional views of tone bars in accordance with the principles of claimed subject matter; and

FIG. 3 is a top plan view of a violin family stringed musical instrument in accordance with the principles of claimed subject matter.

### DETAILED DESCRIPTION

Although claimed subject matter will be described in terms of certain embodiments, other embodiments, including embodiments that do not provide all of the benefits and features set forth herein, are also within the scope of this invention. Accordingly, the scope of the invention is defined only by reference to the appended claims.

In an apparatus and method in accordance with the principles of claimed subject matter, a tone bar may be configured as a treble-side tone bar (also referred to herein as a “treble bar”) for a violin-family stringed musical instrument. In another aspect of an apparatus and method in accordance with the principles of claimed subject matter, a violin family stringed musical instrument tone bar may include features or materials that reduce the mass of the tone bar relative to the mass of conventional tone bars, thereby reducing the damping effects of the tone bar while providing substantially the same support for the instrument's top plate as a conventional tone bar. A violin family stringed musical instrument in accordance with the principles of claimed subject matter may include a treble bar, a bass bar, or both. Either (or both) bars may be reduced-mass tone bars in accordance with the principles of claimed subject matter.

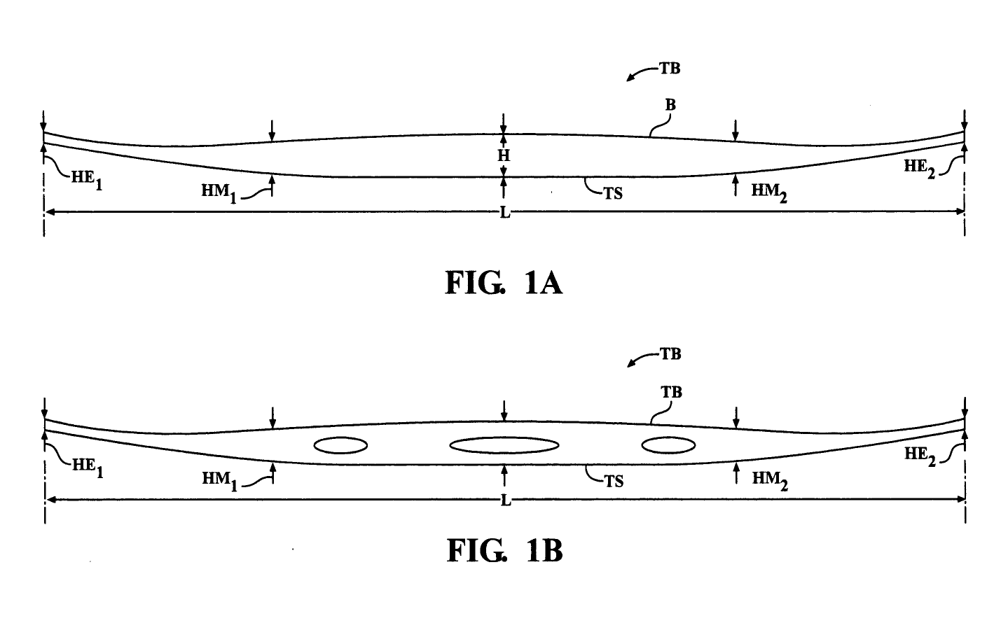

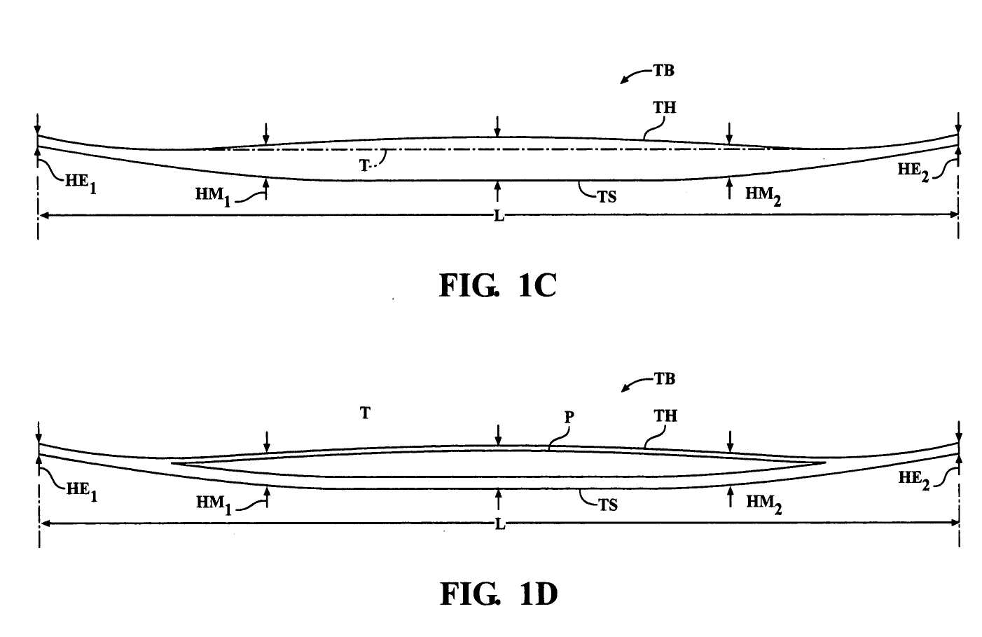

The elevation view of FIG. 1A is of an illustrative embodiment of a tone bar TB which includes a first surface TS adapted for mating with the inside surface of a violin family stringed musical instrument top plate. The first surface TS will also be referred to herein as the “top surface.” Because the instrument's top plate is arched, the top surface TS is curved in order to mate with the inside surface of the instrument's top plate. The body B of the tone bar is configured to project toward a position that would be occupied by the back plate of an instrument to which the tone bar TB may be coupled, in a direction that is generally perpendicular to the top plate of the instrument to which it is to be attached. That is, because a violin family musical instrument soundboard is typically arched, the arching may vary from instrument to instrument and the curve of the arch will typically vary along the length of the instrument. The inside surface of the top plate will therefore typically exhibit a complex set of curves and the direction in which the tone bar body may project may be described as generally perpendicular to the plane of the top plate to which it is attached, with the plane of the top plate being defined by the circumferential edge of the top plate. As is known in the art, the direction of projection needn't be exactly perpendicular to such a plane and, in fact, may vary considerably, as much as ±50°, for example.

The length L, width W, and height H of tone bar TB may be selected according to conventional methods as described, for example, in “Violin Restoration; A Manual For Violin Makers,” by Hans Weisshaar and Margaret Shipman (Weisshaar), which is hereby incorporated by reference. The top surface TS of a treble bar in accordance with the principles of claimed subject matter will be formed to mate with the treble-side inside surface of the top plate of the instrument to which it is destined to mate. The height of the bar TB may vary from lowest values HE1 and HE2 at either end of the tone bar TB, to intermediate values HM1, HM2, to the greatest height H. Weisshaar describes recommended values for various instruments, including: violin, viola and cello. Values for upright basses may be extrapolated from Weisshaar's illustrative recommendations.

The greatest height H may be substantially midway between the ends of the bar TB. In violin family stringed musical instruments that employ both a bass bar and a treble bar, the length L, width W, or height H (and HE1, HE2, HM1 and HM2) of the bars may be reduced from the recommended values for bass bars described in Weisshaar. That is, because the support function of the bars may be distributed across two bars, each bar may be smaller, less massive, and more responsive than would be a conventional bass bar fitted to the same instrument. That is not to say that a tone bar in accordance with the principles of claimed subject matter be longer, shorter, or equal in length to conventional tone bars; all lengths are contemplated within the scope of the invention. In an illustrative embodiment the height H of a tone bar in accordance with the principles of claimed subject matter is no more than 65 mm.

In an illustrative embodiment a tone bar includes at least one region in which the projecting body is narrower than the first surface that is adapted for mating with the inside surface of the violin family instrument soundboard. Such narrowing of the tone bar may be manifested as a “T-shaped” or “I-shaped” cross section, for example, with the first surface forming the “cross” of a T shape or one of the “crosses” of an I shape. Similarly, open regions may be formed in the projecting body. Such narrowings of, or openings within, the projecting body reduce the mass of the tone bar, while, at the same time maintaining the support function of the bar. Such a bar thereby provides the support for an instrument's top plate, while allowing for greater responsiveness to excitation of the instrument's strings.

In the elevation view of FIG. 1B a tone bar TB in accordance with the principles of claimed subject matter may include one or more openings O formed in the body B of the tone bar TB. Openings O operate to reduce the mass of the bar TB while allowing the tone bar TB to provide support for the violin family stringed musical instrument top plate to which it may be mated. Openings O may be sized to reduce the mass of tone bar TB while maintaining the support characteristics of the tone bar TB. In accordance with the principles of claimed subject matter, such openings O may be formed in bass bars or treble bars, whether the bars are integral-to or coupled-to a violin family stringed musical instrument top plate.

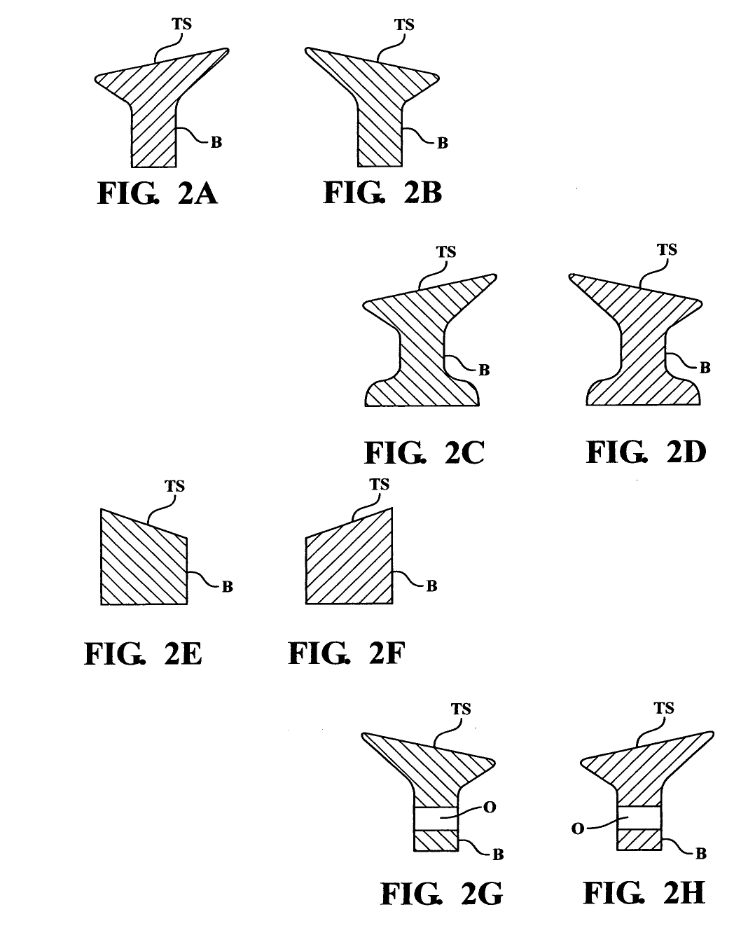

The plan view of FIG. 1C presents an illustrative embodiment of a tone bar in which a region of the body of the tone bar TB is thinned to form a T-shaped cross section in a region TH defined by a line T that delineates a thinned body and wider portion descending from the top surface TS. Illustrative cross sections of the T region are presented in the sectional views of FIGS. 2A and 2B. The plan view of FIG. 1D presents an illustrative embodiment of a tone bar in which a region of the body of the tone bar TB is thinned to form an I-shaped cross section in a region TH defined by a perimeter line P that delineates a thinned body and a wider portion of the tone bar TB. Illustrative cross sections of the I region are presented in the sectional views of FIGS. 2C and 2D.

A tone bar in accordance with the principles of claimed subject matter may include natural materials, such as cedar, or spruce, or synthetic materials, such as carbon fiber, meta-aramid (e.g., Nomex®), or para-aramid (e.g., Kevlar®) material, for example. Laminates and combinations of natural and synthetic materials are contemplated within the scope of the invention.

The sectional view of FIG. 2A illustrates a cross section of a region of an illustrative embodiment of a tone bar TB in accordance with principles of claimed subject matter. In this illustrative embodiment the tone bar TB includes a top surface TS configured to conform to the contour of an inside surface of a violin family musical instrument top plate. The curvature of the top surface TS is exaggerated for illustration. In this illustrative embodiment the cross section is “T-shaped,” the view is looking from the neck end of the bar towards the foot-end of the bar, and the tone bar is a treble bar. That is, the curvature of the top surface is configured to mate with the arching of the inside treble-side surface of a violin family stringed musical instrument top plate. FIG. 2B is of a similar, T-shaped cross section, of a bass bar, as indicated by the opposite slope of the top surface TS. As previously indicated, a T-shaped cross section may be employed to reduce the mass of a tone bar, thereby reducing the damping effect of the tone bar, while substantially maintaining the support capability of the tone bar.

The sectional views of FIGS. 2C and 2D are cross sections of “I-beam shaped” or, simply, “I-shaped” segments of a reduced mass bass- and treble-bars, respectively, in accordance with the principles of claimed subject matter. As with bars that include the T-shaped cross-sectional regions illustrated in FIGS. 2A and 2B, tone bars (treble and bass, respectively) that include I-shaped cross-sectional body B regions may reduce the mass of a tone bar, thereby reducing the damping effect of the tone bar, while substantially maintaining the support capability of the tone bar. The sectional views of FIGS. 2E and 2F are of cross sections of “box” segments of, respectively, treble- and bass-bars in accordance with the principles of claimed subject matter. Such shapes may be employed for an entire tone bar or may be used in combination with other shapes, such at T- or I-shaped cross-section shapes employed along the length of a tone bar, for example. Sectional views of FIGS. 2G and 2F depict cross sections of regions, respectively, of treble-and bass-bars, having openings O that may reduce the mass of a tone bar, thereby reducing the damping effect of the tone bar, while substantially maintaining the support capability of the tone bar. Various treatments of any side of the tone bar, such as chamfers, miters, beading, or cove, are contemplated within the scope of claimed subject matter.

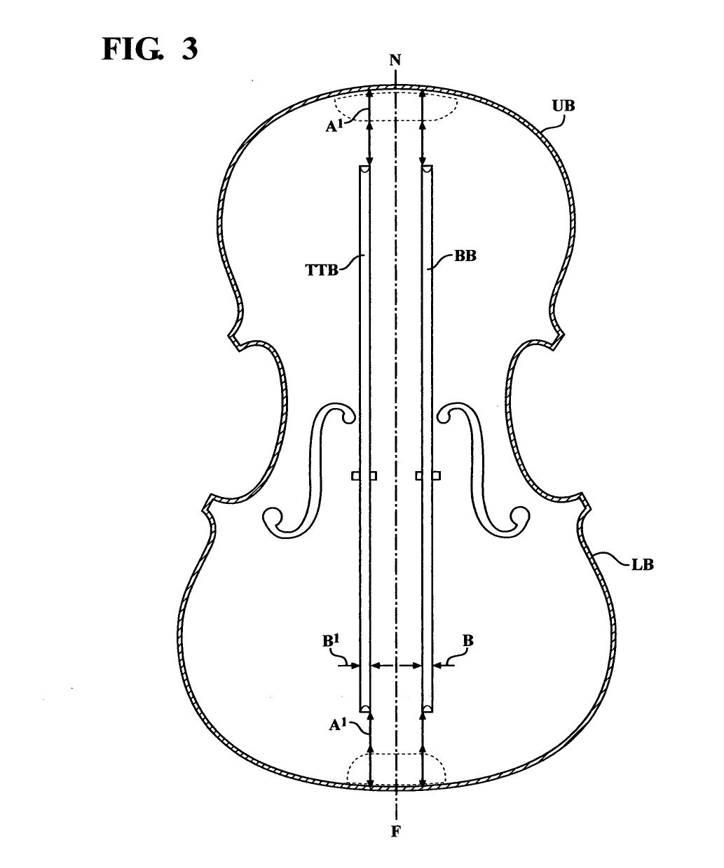

The top plan view of FIG. 3 depicts the positioning of a treble bar TTB and a bass bar on the top plate TP of a violin family stringed musical instrument. As previously indicated, either or both of the treble TTB and bass BB tone bars may be of reduced-mass configuration, as previously described. Both bars are substantially straight and extend along respective lines from the foot F to the neck N of the violin family stringed musical instrument. In an illustrative embodiment the treble TTB and bass BB bars are angled in proportion to the difference in width of the upper bout UB and lower bout LB. As previously indicated, the height, width, and length of a bar BB may be selected according to a known process such as set forth in Weisshaar.

The placement of a bass bar BB on the surface of an instrument's top plate is also disclosed in Weisshaar. A treble bar TTB in accordance with the principles of claimed subject may be positioned, for example, in mirror-relation to the placement described for a bass bar BB. For example, the distance A′ from the upper and lower ends of the top plate to the treble bar TTB may be selected as indicated for the distance A for the distance from the upper and lower ends of the top plate to the bass bar (4 cm, 4 cm, 8 cm, and 9 cm respectively recommended for violin, viola, cello, and bass). Similarly, the thickness B′ of the treble bar may be the same as recommended for a bass bar B (5.5-6, 6-6.5, 10.5 mm, and 15-25 mm respectively, for violin, viola, cello, and bass). Heights HE1, HM1, H, HM2, HE2 referred to in FIG. 1A may be the same for bass and treble bars respectively, 3, 9-10, 11-13, 9-10, 3 mm for violin, 5-6, 16-18, 21-23, 16-18, 5-6 for cello, and 14, 30, 45, 30, 14 mm for a bass, for example). The proportion of upper and lower bout division for the angle of a tone bar may be the same for both treble and bass (1/7, 1/7, 1/5, and 1/7 respectively, for violin, viola, cello, and bass). And the distance F between the outer edge of the bridge foot and the bass bar may be the same for bass and treble tone bars (1.5, 1.5-2, 3-5 mm, and 3-5 mm, respectively, for violin, viola, cello, and bass, for example). As is known in the art, recommended tone bar dimensions are starting points and the finished dimensions of such bars may be arrived at through various adjustment techniques, such as “tap testing,” for example.

Just as tone bar BB (bass bar) includes a top surface adapted for mating with the inside surface of a violin family stringed musical instrument's top plate, tone bar TTB (treble bar) includes a first surface adapted for mating with the inside surface of the treble side of a violin family soundboard and a tone bar body that may project generally perpendicular to the plane of the top plate to which it is attached. Such a tone bar may exhibit an otherwise conventional, substantially rectilinear, shape, for example. In other embodiments, a treble bar may be formed in a reduced-mass manner, employing, for example, at least one region in which the body is narrower than the first surface that is adapted for mating with the inside treble surface of the violin family instrument soundboard. Again, such narrowing of the tone bar may be manifested as a “T-shaped” or “I-shaped” cross section, for example, with the first surface forming the cross of a T shape or one of the crosses of an I shape, as described in the discussion related to FIGS. 1A through 1D and FIGS. 2A through 2H. Mass reduction may also be achieved, as previously described, by including openings within the body of the bar, for example. The tone bar may be composed of natural materials, such as cedar, or spruce, or synthetic materials, such as carbon fiber, meta-aramid (e.g., Nomex®), or para-aramid (e.g., Kevlar®) material, for example. Laminates and combinations of natural and synthetic materials are contemplated within the scope of the invention.

In accordance with the principles of claimed subject matter, a violin family instrument includes a tone bar located on the inside treble side of the instrument's soundboard. The tone bar may be integral to the soundboard or may be coupled to the inside of the soundboard using, for example, an adhesive such as an animal-hide glue. Such an instrument may also include a tone bar located on the inside bass side of the instrument's soundboard. Either tone bar may exhibit an otherwise conventional, substantially rectilinear, shape, or may include at least one region in which the body is narrower than the first surface that is adapted for mating with the inside treble surface of the violin family instrument soundboard. Such narrowing of the tone bar may be manifested as a “T-shaped” or “I-shaped” cross section, for example, with the first surface forming the cross of a T shape or one of the crosses of an I shape. Voids may be included within the body of either bar to reduce the mass of the respective bar and to thereby reduce damping attributable to the bar. Either tone bar may be composed of natural materials, such as cedar, or spruce, or synthetic materials, such as carbon fiber, for example. Laminates and combinations of natural and synthetic materials are contemplated within the scope of the invention. Violin family musical instruments in accordance with the principles of claimed subject matter may include one or more tone bars that are either attached to, or integral with, the instrument. Because a treble bar provides support for an instrument's top plate, instruments that include both a bass bar and a treble bar, may employ a smaller bass bar than would be conventional, thereby further reducing mass and improving responsiveness. The treble bar may also be smaller than a conventional bass bar.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments. While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

1. An apparatus, comprising:
a tone bar having a first surface adapted for mating with an inside surface of a violin family instrument sound board on the treble side of the sound board; and
a second surface substantially opposed to the first surface, the distance between the first and second surfaces defining the height of the bar, the height of the bar being no more than 65 mm at any point.

2. The apparatus of claim 1 wherein the bar comprises cedar wood.

3. The apparatus of claim 1 wherein the bar comprises spruce wood.

4. The apparatus of claim 1 wherein the bar comprises synthetic material.

5. The apparatus of claim 1 wherein the tone bar includes a region having a cross-section that is substantially I-shaped, with the top surface forming a crossing member of the I.

6. The apparatus of claim 1 wherein the tone bar includes a region having a cross-section that is substantially T-shaped, with the top surface forming the crossing member of the T.

7. The apparatus of claim 1 wherein the tone bar includes a region having an opening from one side of the tone bar to the other.

8. An apparatus, comprising:
a tone bar comprising synthetic material having a first surface adapted for mating with an inside surface of a violin family instrument sound board on the bass side of the sound board; and
a second surface substantially opposed to the first surface, the distance between the first and second surfaces defining the height of the bar, the height of the bar being no more than 65 mm at any point.

9. An apparatus, comprising:
a tone bar having a first surface adapted for mating with an inside surface of a violin family instrument sound board on the bass side of the sound board; and
a second surface substantially opposed to the first surface, the distance between the first and second surfaces defining the height of the bar, the height of the bar being no more than 65 mm at any point, the bar including a reduced-mass region.

10. The tone bar of claim 9 wherein the reduced mass region has a cross-section that is substantially I-shaped, with the top surface forming a crossing member of the I.

11. The tone bar of claim 9 wherein the reduced mass region has a cross-section that is substantially T-shaped, with the top surface forming the crossing member of the T.

12. The tone bar of claim 9 wherein the reduced mass region includes an opening from one side of the tone bar to the other.

13. A violin family instrument, comprising:
a sound board;
sides;
a back; and
a tone bar positioned on the inside surface of the sound board on the treble side of the sound board.

14. The violin family instrument of claim 13 wherein the tone bar is integral to the sound board.

15. The violin family instrument of claim 13 wherein the tone bar comprises natural material.

16. The violin family instrument of claim 13 wherein the tone bar comprises synthetic material.

17. The violin family instrument of claim 13 wherein the tone bar comprises a reduced mass region.

18. A violin family instrument, comprising:
a sound board;
sides;
a back;
a tone bar positioned on the inside surface of the sound board on the bass side of the sound board; and
a tone bar positioned on the inside surface of the sound board on the treble side of the sound board.

19. The violin family instrument of claim 18 wherein a tone bar comprises synthetic material.

20. The violin family instrument of claim 18 wherein a tone bar comprises a reduced mass region.
